(19) United States
(12) Patent Application Publication
(10) Pub. No.: US 2009/0210610 A1
(43) Pub. Date: Aug. 20, 2009

(54) Computer system, data relay device and control method for computer system

(75) Inventor: Takashi KOGUCHI, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/385,916

(22) Filed: Apr. 23, 2009

Related U.S. Application Data
(63) Continuation of application No. PCT/JP2006/321567, filed on Oct. 27, 2006.

(51) Int. Cl. G06F 13/00; G06F 11/07

(52) U.S. Cl. 710/317; 714/52; 714/E11.024

(57) ABSTRACT

A computer system includes a plurality of system boards each of which includes two systems arranged in a duplicated structure and a data relay device. The data relay device includes a degeneration determining unit that determines whether each of the systems is degenerated based on a signal that is transmitted from the each of the systems; a dummy-information creating unit that creates dummy information by adding dummy data to identification information and destination information, the identification information indicating a head of proper data that is transmitted from one of the systems constituting the duplicated structure with the other system that has been determined as being degenerated, and the destination information indicating destination of the data; and a data transmitting unit that transmits, as synchronized data, proper information that is transmitted from the one of the systems, and the dummy information.

### CROSS-REFERENCE TO RELATED APPLICATION(S)

This application is a continuation of PCT international application Ser. No. PCT/JP2006/321567 filed on Oct. 27, 2006 which designates the United States, the entire contents of which are incorporated herein by reference.

### FIELD

The embodiments discussed herein are directed to a computer system in which system boards each of which includes two systems arranged in a duplicated structure are connected through a data relay device and in which synchronized data is communicated through the data relay device, a data relay device that is connected to system boards each of which is includes two system arranged in a duplicated structure and that controls transmission of synchronized data sent from the respective system boards, and a control method for a computer system in which system boards each of which is includes two systems arranged in a duplicated structure are connected through a data relay device and in which communication of synchronized data is controlled through the data relay device.

### BACKGROUND

Conventionally, techniques that enable to improve reliability of computer systems such as an information processing apparatus have been disclosed (for example, see Japanese Patent No. 3050148).

As exemplified in FIG. 7, in a computer system that is configured by connecting a plurality of system boards in each of which a central processing unit (CPU) functioning as a main control unit, a memory functioning as a storage unit, a memory controller, and a system controller are arranged, through a data cross bar and an address cross bar, it is common to arrange the respective devices such as the memory and the memory controller in a duplicated manner on the system board to improve the reliability of the system.

However, in such a computer system in which the respective devices are duplicated on the system board, degeneracy of a device on non-broken system board is needed, and therefore, the system availability is low.

This problem is explained briefly. As depicted in FIG. 8, devices arranged on each of system boards (#0 to #2) and a data cross bar are duplicated in mirrors A and B, and the mirrors A and B are synchronized. If a failure occurs in a device constituting the mirror A on the system board #0, the mirror A of the system board #0 is closed, and transmission of data from the mirror A of the system board #0 to the mirror A of the data cross bar is stopped. The cross bar that performs transmission of data among the respective system boards cannot continue a synchronization operation in which data received from the mirrors A and B are synchronized to be transmitted. When other system boards cannot receive data synchronized at the mirrors A and B, the system boards cannot determine validity of received data. As a result, the mirror A in each of the other system boards working normally has to be closed for degeneracy.

### SUMMARY

According to an aspect of the invention, a computer system includes a plurality of system boards each of which includes two systems arranged in a duplicated structure; and a data relay device that is connected to the system boards and controls transmission of synchronized data transmitted from the system boards. The data relay device includes a degeneration determining unit that determines whether each of the systems is degenerated based on a signal that is transmitted from the each of the systems; a dummy-information creating unit that creates dummy information by adding dummy data to identification information and destination information, the identification information indicating a head of proper data that is transmitted, in response to a data request from the system board, from one of the systems constituting the duplicated structure with the other system that has been determined as being degenerated by the degeneration determining unit, and the destination information indicating destination of the data; and a data transmitting unit that transmits, as synchronized data, proper information that is transmitted from the one of the systems in response to a data request from the system board, and the dummy information that is created by the dummy-information creating unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWING(S)

FIG. 1 is a schematic diagram for explaining an outline and features of a computer system according to a first embodiment of the present invention;

FIG. 2 is a block diagram of the computer system according to the first embodiment;

FIG. 3 is an example of a configuration of a data packet according to the first embodiment;

FIG. 4 is a block diagram of a data cross bar according to the first embodiment;

FIG. 5 is a block diagram of an IN port of the data cross bar according to the first embodiment;

FIG. 6 is a flowchart of a process performed in the IN port of the data cross bar according to the first embodiment;

FIG. 7 is a schematic diagram for explaining a conventional technique; and

FIG. 8 is another schematic diagram for explaining a conventional technique.

### DESCRIPTION OF EMBODIMENT(S)

Preferred embodiments of a computer system, a data relay device, and a control method for the computer system according to the present invention will be explained below in detail with reference to the accompanying drawings. After a system computer according to a first embodiment of the present invention is explained, other embodiments of the present invention are explained.

### [a] First Embodiment

In the first embodiment, an outline and features of the computer system according to the first embodiment, a configuration of the computer system, and a process performed thereby are explained in order, and effects of the first embodiment are explained at the end.

[Outline and Features of Computer System (First Embodiment)]

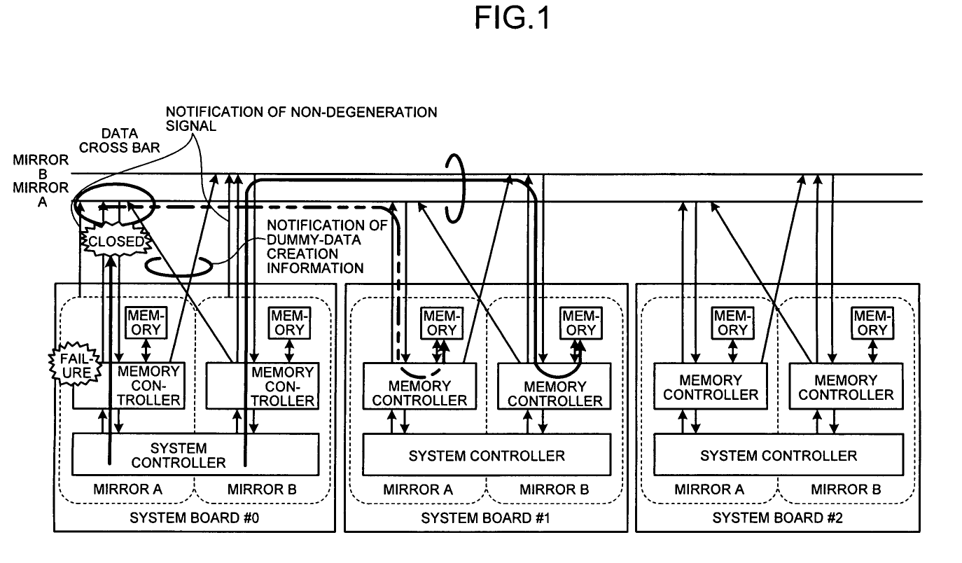

An outline and features of the computer system according to the first embodiment are first explained with reference to FIG. 1. FIG. 1 is a schematic diagram for explaining an outline and features of the computer system according to the first embodiment.

The outline of the computer system according to the first embodiment is as follows. System boards each of which includes two systems arranged in duplication are connected through a data relay device, and synchronized data is communicated through the data relay device. The main feature of the computer system is that degeneracy of a non-broken system board is not needed, the synchronization operation can be continued, and the availability of the system can be enhanced.

The main feature is specifically explained. As exemplified in FIG. 1, the computer system according to the first embodiment includes a plurality of system boards (system boards #0 to #2) and a data cross bar functioning as a data relay device that is connected to the system boards. Each of the system boards includes two systems, i.e. mirrors A and B, in which devices such as the memory and the memory controller are arranged in a duplicated structure.

The data cross bar includes a mirror A that transmits data received from the mirror A of each of the system boards, and a mirror B that transmits data received from the mirror B of each of the system boards.

The mirrors A and B on each of the system boards are connected to the mirrors A and B of the data cross bar through a signal bus to output a non-degeneration signal that indicates a not-degenerated state (for example, signal indicating ALIVE), and a data bus to send and receive data. Meanwhile, the mirrors A and B on each of the system boards are connected to the mirrors A and B of the data cross bar through a dummy-data-creation-information notifying bus to give dummy-data creation information to create dummy data.

A case that the mirror A of the system board #0 is degenerated due to a failure or the like is explained as an example.

Responding to a data request from the system board #1, the mirror B of the system board #0 constituting the computer system sends a data packet corresponding to the request and dummy-data-creation information. Specifically, the mirror B of the system board #0 sends a data packet including identification information (for example, “DATA_VALID”) indicating the head of the data packet corresponding to the request, destination information (for example, “DIST_BOARD_ID”) indicating a system board of a destination of the data packet, and the data itself to the mirror B of the data cross bar through the data bus.

At the same time, the mirror B of the system board #0 sends, as the dummy-data creation information, identification information (for example, “OTHER_DATA_VALID”) indicating the head of the data packet corresponding to the request, and destination information (for example, “OTHER_DIST_BOARD_ID”) indicating a system board of a destination of the data packet to the mirror A of the data cross bar through the dummy-data-creation-information notifying bus.

When it is determined that the mirror of the system board #0 to which the data cross bar is connected is not degenerated based on the non-degeneration signal received from the system board #0, the data cross bar controls the data packet received from the system board #0 to be transmitted. On the other hand, when it is determined that the mirror to which the data cross bar is connected is degenerated based on the non-degeneration signal received from the system board #0, the data cross bar controls the created dummy information to be transmitted as a data packet.

Specifically, a case that the mirror A of the system board #0 is degenerated is explained as an example. When the mirror B of the data cross bar can confirm the non-degeneration signal from the mirror B of the system board #0, the mirror B of the data cross bar determines that the mirror B of the system board #0 to which the data cross bar is connected is not degenerated, and determines a system board to be a destination based on the destination information included in the data packet received from the mirror B of the system board #0 to which the data cross bar is connected to transmit the data packet to the destination.

On the other hand, the mirror A of the data cross bar creates dummy information using the dummy-data creation information received from the mirror B of the system board #0. Specifically, the mirror A of the data cross bar creates the dummy information by adding poisoning data (data that is not detected as a correctable error or an uncorrectable error, and that cannot be proper data, either) to be used as the dummy data to the dummy-data creation information received from the mirror B of the system board #0. When the mirror A of the data cross bar can not confirm the non-degeneration signal from the mirror A of the system board #0, the mirror A of the data cross bar determines that the mirror A is degenerated, and determines a system board to be a destination based on the destination information included in the created dummy information to send the dummy information as a data packet to the destination.

That is, the data cross bar sends the data packet received from the mirror B of the system board #0, and a data packet including the dummy information that is created based on the dummy-data creation information received from the mirror B in place of a data packet that is not received from the mirror A of the system board #0 because of degeneration thereof, to a system board that is determined as the destination (for example, the system board #1), in a synchronized manner.

As described above, according to the first embodiment, the synchronization operation of the mirrors A and B can be continued, and degeneracy of a non-broken system board is not needed, and the duplication is maintained. Therefore, the availability of the system can be enhanced.

[Configuration of Computer System (First Embodiment)]

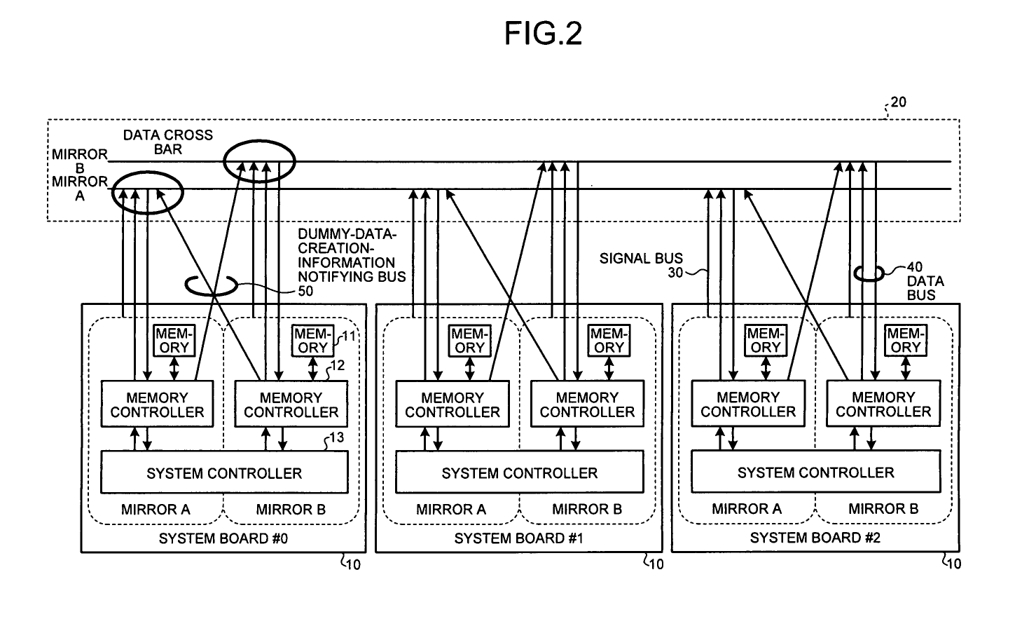

A configuration of the computer system according to the first embodiment is explained next with reference to FIG. 2. FIG. 2 is a block diagram of the computer system according to the first embodiment.

As depicted in FIG. 2, the computer system according to the first embodiment is configured by connecting system boards 10 (system boards #0 to #2) each of which includes mirrors A and B with which devices such as a memory 11, a memory controller 12, and a system controller 13 are duplicated, through a data cross bar 20 that includes a mirror A that transmits data received from the mirror A of each of the system boards 10 and a mirror B that transmits data received from the mirror B of each of the system boards 10.

The computer system according to the first embodiment includes signal buses 30, data buses 40, and dummy-data-creation-information notifying buses 50. Each of the signal bases 30 is used to send a non-degeneration signal indicating that the mirror A or B on each of the system boards 10 is not degenerated (for example, a signal indicating ALIVE). Each of data buses 40 is used so that the mirrors A and B on each of the system boards 10 sends or receives data. Each of dummy-data-creation-information notifying buses 50 is used to give dummy-data creation information for the mirrors A and B on each of the system boards 10 to create dummy data.

In the computer system according to the first embodiment, the mirror A on each of the system boards 10 and the mirror A of the data cross bar 20, as well as the mirror B of each of the system boards 10 and the mirror B of the data cross bar 20 are connected through the signal bus 30 and the data bus 40. On the other hand, the mirror A on each of the system boards 10 and the mirror B of the data cross bar 20, as well as the mirror B of each of the system boards 10 and the mirror A of the data cross bar 20 are connected through the dummy-data-creation-information notifying bus 50.

Each of the system boards 10 includes devices such as the memory 11, the memory controller 12, the system controller 13, and a CPU (not depicted), and controls various types of information processing. The memory 11 stores therein data and programs required for the various types of information processing.

The memory controller 12 controls access to the memory 11, and has a function as an input/output (I/O) port between the system board 10 and the data cross bar 20. Moreover, the memory controller 12 transmits, responding to a data request from the system board #1, a data packet corresponding to the request and dummy-data creation information.

Specifically, when the memory controller 12 on each of the system board (for example, the system board #0) receives a request for data that is managed in the memory 11 provided thereto, the memory controller 12 sends the identification information (for example, “DATA_VALID”) indicating the head of a data packet corresponding to the request and the destination information (for example, “DIST_BOARD_ID”) indicating a system board of the destination of the data packet to a corresponding mirror of the data cross bar 20 (for example, in case of the mirror A of the system board #0, the information are transmitted to the mirror A of the data cross bar 20) through the data bus 40.

At the same time, the memory controller 12 sends the identification information (for example, “OTHER_DATA_VALID”) indicating the head of the data packet corresponding to the request, and the destination information (for example, “OTHER_DIST_BOARD_ID) indicating a system board of the destination of the data packet to the other mirror (for example, in case of the mirror A of the system board #0, the information are transmitted to the mirror B of the data cross bar 20) constituting the duplicated structure with the corresponding mirror of the data cross bar 20 through the dummy-data-creation-information notifying bus 50 as the dummy-data creation information.

The system controller 13 controls the entire system concerning various types of information processing such as data transmission to the memory 11, and uses an error correcting code (ECC).

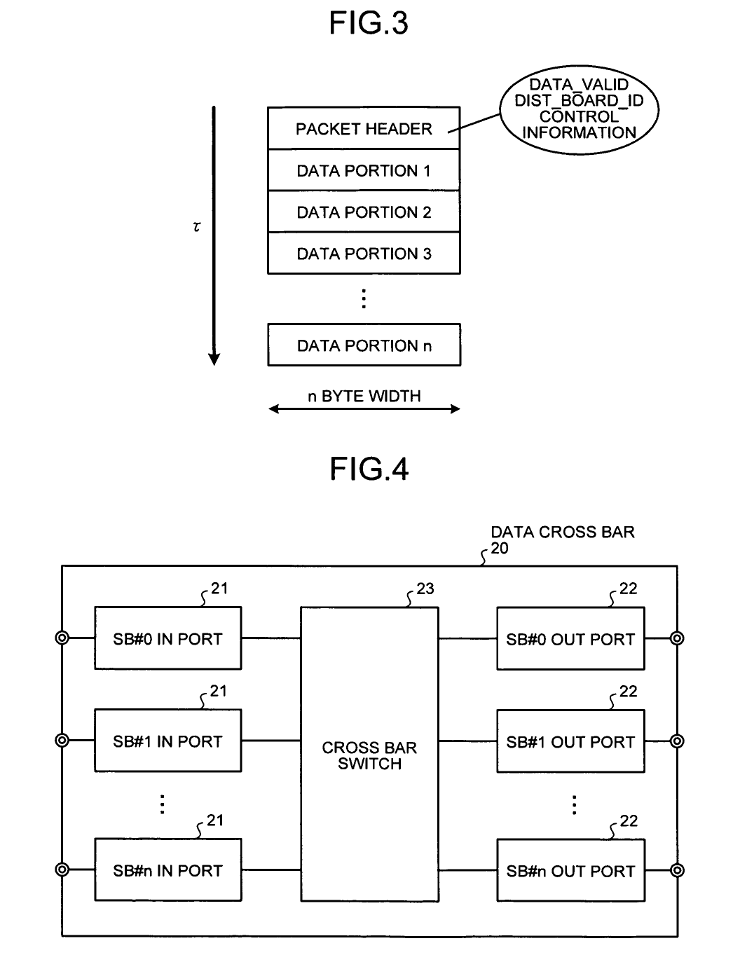

The data cross bar 20 is a relay device that transmits a data packet communicated among the system boards 10. A configuration of this data packet is explained briefly. As depicted in FIG. 3, a data packet includes a packet header that indicates information of a data packet and the body of data including a plurality of data portions (for example, data portions 1 to n). The packet header includes the identification information (for example, “DATA_VALID” or “OTHER_DATA_VALID”) indicating the head of the data packet, the destination information (for example, “DIST_BOARD_ID” or “OTHER_DIST_BOARD_ID”) indicating a system board of the destination of the data packet, and necessary control information.

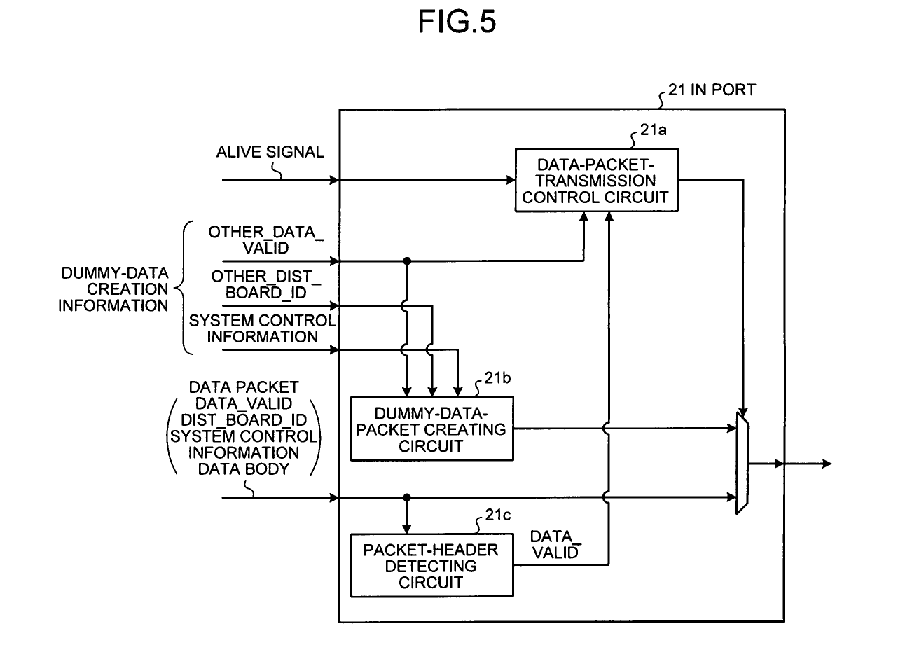

A configuration of the data cross bar 20 is explained in detail with reference to FIGS. 4 and 5. FIG. 4 is a block diagram of the data cross bar 20 according to the first embodiment. FIG. 5 is a block diagram of an IN port of the data cross bar 20 according to the first embodiment.

As depicted in FIG. 4, the data cross bar 20 includes IN ports 21 that are connected to output data buses of the system boards 10, respectively, OUT ports 22 that are connected to input data buses of the system boards 10, respectively, and a cross bar switch 23 that connects the IN ports 21 and the OUT ports 22 with each other. The cross bar switch 23 synchronizes a data packet received from the IN port 21 (described later in detail) and a data packet including the dummy information to send to the OUT port 22.

As depicted in FIG. 5, the IN port 21 of the data cross bar 20 includes a data-packet-transmission control circuit 21a, a dummy-data-packet creating circuit 21b, and a packet-header detecting circuit 21c.

The data-packet-transmission control circuit 21a controls to transmit a data packet that is received from the system board 10 when it is determined that the mirror of the system board 10 to which the data-packet-transmission control circuit 21a is connected is not degenerated based on the non-degeneration signal that is received from the system board 10. On the other hand, the data-packet-transmission control circuit 21a controls to transmit the created dummy information as a data packet when it is determined that the mirror of the system board 10 to which the data-packet-transmission control circuit 21a is connected is degenerated based on the non-degeneration signal that is received from the system board 10.

Specifically, a case that the mirror A of the system board #0 is degenerated is explained as an example. The data-packet-transmission control circuit 21a constituting the mirror B of the data cross bar 20 constantly monitors whether the non-degeneration signal (for example, ALIVE signal) is notified from the mirror B of the system board #0 to which the data-packet-transmission control circuit 21a is connected. When the data-packet-transmission control circuit 21a can confirm the non-degeneration signal from the mirror B of the system board #0 to which the data-packet-transmission control circuit 21a is connected (for example, the signal information is “ON”), the data-packet-transmission control circuit 21a determines that the mirror B of the system board #0 to which the data-packet-transmission control circuit 21a is connected is not degenerated. Upon receiving the identification information (for example, “DATA_VALID”) indicating the head of the data packet from the system board #0 through the data bus 40, the data-packet-transmission control circuit 21a determines a system board to be the destination based on the destination information (for example, “DIST_BOARD_ID”) further included in the data packet and sends the received data packet to the cross bar switch 23.

On the other hand, the data-packet-transmission control circuit 21a constituting the mirror A of the data cross bar 20 constantly monitors whether the non-degeneration signal (for example, ALIVE signal) is notified from the mirror A of the system board #0 to which the data-packet-transmission control circuit 21a is connected. When the data-packet-transmission control circuit 21a can not confirm the non-degeneration signal from the mirror A of the system board #0 to which the data-packet-transmission control circuit 21a is connected (for example, when the signal information is not “ON”), the data-packet-transmission control circuit 21a determines that the mirror A of the system board #0 to which the data-packet-transmission control circuit 21a is connected is degenerated. Upon receiving the dummy-data creation information including the identification information (for example, “OTHER_DATA_VALID”) indicating the head of the data packet from the system board #0 through the dummy-data-creation-information notifying bus 50, the data-packet-transmission control circuit 21a determines a system board to be the destination based on the destination information (for example, “OTHER_DIST_BOARD_ID”) further included in the dummy-data creation information, and transmits the dummy information that is created by the dummy-data-packet creating circuit 21b described later to the cross bar switch 23 as a data packet to be transmitted to the system board of the destination.

The data-packet-transmission control circuit 21a receives the identification information (for example, “DATA_VALID”) indicating the head of the packet data that is transmitted from a mirror (for example, the mirror A) of the system board 10 to which the data-packet-transmission control circuit 21a is connected, from the packet-header detecting circuit 21c described later, and receives the identification information (for example, “OTHER_DATA_VALID”) indicating the head of the packet data that is included in the dummy-data creation information transmitted through the dummy-data-creation-information notifying bus 50, from a mirror (for example, the mirror B) forming the duplicated structure with the mirror of the system board 10 to which the packet-header detecting circuit 21c is connected.

The dummy-data-packet creating circuit 21b creates dummy information using the dummy-data creation information received through the dummy-data-creation-information notifying bus 50. Specifically, when the dummy-data-packet creating circuit 21b receives the dummy-data creation information including the identification information (for example, “OTHER_DATA_VALID”) indicating the head of a packet and the destination information (for example, “OTHER_DIST_BOARD_ID”) indicating the destination of the packet from the mirror (for example, the mirror B) constituting the duplicated structure with the mirror (for example, the mirror A) of the system board 10 (for example, system board #0) to which the dummy-data-packet creating circuit 21b is connected, the dummy-data-packet creating circuit 21b creates the dummy information by adding poisoning data (data that is not detected as a correctable error or an uncorrectable error, and that cannot be proper data, either) to be used for a data body as the dummy data to the dummy-data creation information.

The packet-header detecting circuit 21c detects a packet header of a data packet received from the system board 10, and transmits the detected packet header to the data-packet-transmission control circuit 21a.

Specifically, when the non-degeneration signal from the mirror of the system board 10 to which the data cross bar 20 is connected is confirmed and it is determined that the mirror is not degenerated, the data cross bar 20 transmits a data packet received from the mirror to which the data cross bar 20 is connected, to the system board 10 of the destination at such timing that the identification information (for example, “DATA_VALID”) indicating the head of the data packet included in the received data packet becomes available (for example, at a timing when a queue buffer of the cross bar switch 23 accepts data reception). On the other hand, when the non-degeneration signal from the mirror of the system board 10 to which the data cross bar 20 is connected is not confirmed and it is determined that the mirror is degenerated, the data cross bar 20 transmits created dummy information to the system board 10 of the destination as a data packet at such timing that the identification information (for example, “OTHER_DATA_VALID”) indicating the head of the data packet included in the received dummy-data creation information becomes available.

[Process Performed by Computer System (First Embodiment)]

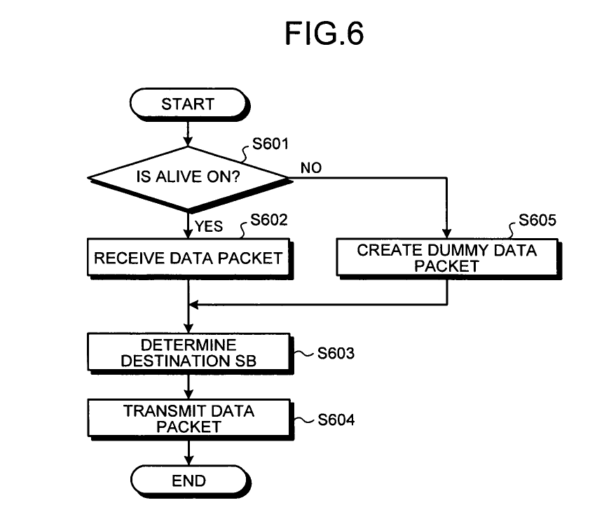

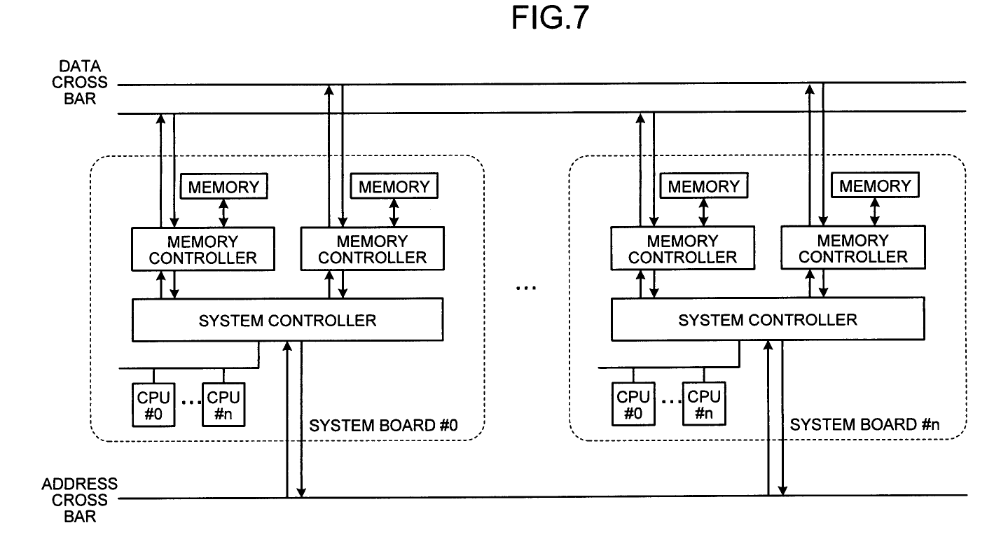

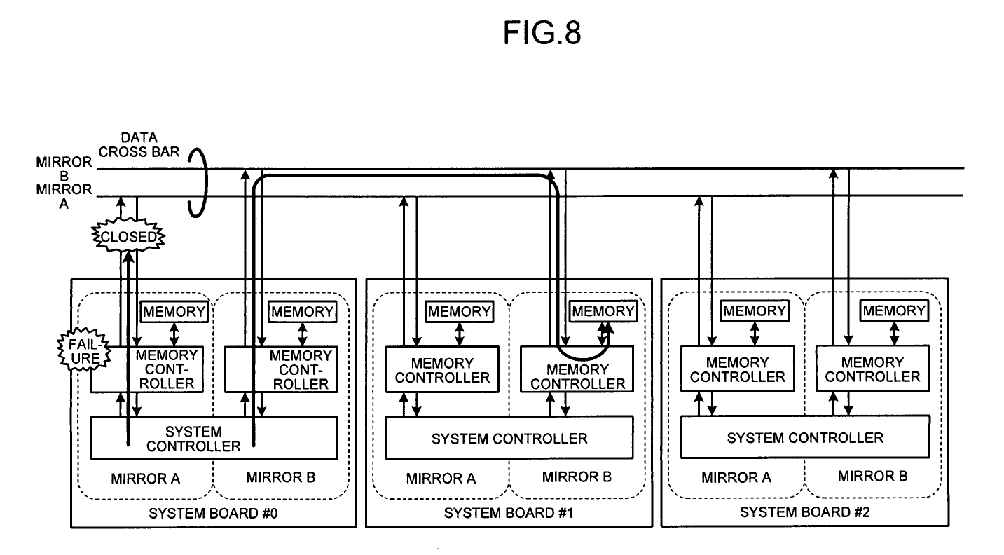

A process performed in the IN port of the data cross bar constituting the computer system according to the first embodiment is explained with reference to FIG. 6. FIG. 6 is a flowchart of the process performed in the IN port of the data cross bar according to the first embodiment.

As depicted in FIG. 6, the data-packet-transmission control circuit 21a constantly monitors the non-degeneration signal (for example, ALIVE signal) transmitted from a mirror of the system board 10 to which the data-packet-transmission control circuit 21a is connected, and checks whether the non-degeneration signal is notified (for example, whether the signal information is “ON”) (Step S601).

When the non-degeneration signal is confirmed as a result of the check (for example, when the signal information is “ON”) (YES at Step S601), the data-packet-transmission control circuit 21a determines that the mirror of the system board 10 to which the data-packet-transmission control circuit 21a is connected is not degenerated. When it is determined that the mirror to which the data-packet-transmission control circuit 21a is connected is not degenerated, and when the data-packet-transmission control circuit 21a receives the identification information (for example, “DATA_VALID”) indicating the head of the data packet included in a received data packet (Step S602), the data-packet-transmission control circuit 21a determines a system board of the destination based on the address information (for example, “DIST_BOARD_ID”) included in the data packet (Step S603), and transmits the received data packet to the cross bar switch 23 (Step S604).

On the other hand, when the non-degeneration signal is not confirmed as a result of the check (for example, when the signal information is not “ON”) (NO at Step S601), the data-packet-transmission control circuit 21a determines that the mirror of the system board to which the data-packet-transmission control circuit 21a is connected is degenerated.

The dummy-data-packet creating circuit 21b then creates dummy information using dummy-data creation information received through the dummy-data-creation-information notifying bus 50 (Step S605). Specifically, on the system board 10 (for example, the system board #0), when the dummy-data-packet creating circuit 21b receives the dummy-data creation information including the identification information (for example, “OTHER_DATA_VALID”) indicating the head of the packet and the destination information (for example, “OTHER_DIST_BOARD_ID”) indicating the destination of the packet from the mirror (for example, the mirror B) forming the duplicated structure with the mirror (for example, the mirror A) of the system board 10 to which the dummy-data-packet creating circuit 21b is connected, the dummy-data-packet creating circuit 21b creates the dummy information by adding poisoning data (data that is not detected as a correctable error or an uncorrectable error, and that cannot be proper data, either) to be used for a data body as the dummy data to the dummy-data creation information.

When it is determined that the mirror of the system board to which the dummy-data-packet creating circuit 21b is connected is degenerated (NO at Step S601), and when the dummy-data-packet creating circuit 21b receives the dummy-data creation information including the identification information (for example, “OTHER_DATA_VALID”) indicating the head of the data packet from the system board #0 through the dummy-data-creation-information notifying bus 50, the data-packet-transmission control circuit 21a determines a system board of the destination based on the destination information (for example, “OTHER_DIST_BOARD_ID”) further included in the dummy-data creation information (Step S603), and transmits the dummy information that is created by the dummy-data-packet creating circuit 21b to the cross bar switch 23 as a data packet to be transmitted to the system board determined to be the destination (Step S604).

[Effects of First Embodiment]

As described above, according to the first embodiment, it is determined whether one of two systems (for example, the mirrors A) constituting the duplicated structure in each of the system boards 10 is degenerated based on a signal that is transmitted from the one system, and whether the other system (for example, the mirror B) is degenerated based on a signal that is transmitted from the other system. For example, the degeneration is checked by constantly monitoring a signal indicating no degeneration has occurred that is sent out from each of the two systems of each system board. Further, dummy information is created by adding dummy data (not proper data) to identification information indicating the head of proper data (data corresponding to a data request), i.e. information indicating the head of a data packet, that is transmitted, from one of the systems (not degenerated system) constituting the duplicated structure with the other system that has been determined as being degenerated, in response to the data request from the system board 10, and destination information indicating the destination of the proper data (information indicating a system board of the destination of the data). Furthermore, the created dummy information is transmitted together with the proper information transmitted from the one of the systems constituting the duplicated structure with the other system that has been determined as being degenerated, in response to the data request. Therefore, degeneration of a system board without failure is not necessary. Accordingly, the duplication of data is maintained among system boards in which neither failure in a device nor degeneration of one of systems constituting the duplicated structure has occurred, and as a result, availability of the system can be improved.

Poisoning data (data that is not detected as a correctable error or an uncorrectable error, and that cannot be proper data, either) that is recognized as a dummy from a result of decoding by an error detecting code is used for the dummy data, and dummy information including the identification information, the destination information, and the poisoning data is created. Therefore, in a computer system in which the ECC or the like is used as the error detecting code, a synchronization operation can be continued by creating the dummy data while using a conventional configuration, and as a result, the availability of the system can be effectively improved.

While the first embodiment of the present invention has been explained above, the present invention can be also carried out in various other embodiments. Other embodiments included in the present invention are explained below.

(1) Creation of Dummy Information by Adding Information Indicating it is Dummy

While in the first embodiment, a case that the dummy-data-packet creating circuit 21b creates the dummy information using the dummy-data creation information and the poisoning data that is used for a data body has been explained, the present invention is not limited thereto. The dummy information can be created by adding information indicating it is a dummy (for example, by adding one bit of information indicating it is a dummy to the header portion of a data packet) to the identification information indicating the head of the packet, the destination information indicating the destination of the packet, and the dummy data to be the data body.

By this method, even when a function of creating and checking the poisoning data is not provided, the dummy information can be created with a simple configuration, and the availability of the system can be improved.

(2) Device Configuration

Each constituent element of the IN port 21 of the data cross bar 20 according to the first embodiment depicted in FIG. 5 is functionally conceptual, and it is not required to be configured physically as depicted. That is, the specific mode of dispersion and integration of the IN port 21 is not limited to the depicted in the figure, but all or a part thereof may be distributed or integrated functionally or physically in an arbitrary unit according to various kinds of load and the status of use, for example by integrating the data-packet-transmission control circuit 21a and the packet-header detecting circuit 21c.

Furthermore, each processing function (a data-packet-transmission control function, a dummy-data-packet creating function, and a packet-header detecting function, see FIG. 6 or the like) implemented by the data cross bar 20 are not limited to a case that the functions are implemented by the data cross bar 20. For example, each function can be implemented by providing predetermined circuits or the like in each of the memory controllers 12 arranged on each of the system boards 10, and by transmitting dummy information created by the memory controller 12 that is not degenerated to the data cross bar 20 as a data packet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A computer system comprising:
a plurality of system boards each of which includes two systems arranged in a duplicated structure; and
a data relay device that is connected to the system boards and controls transmission of synchronized data transmitted from the system boards,
wherein the data relay device comprises:
a degeneration determining unit that determines whether each of the systems is degenerated based on a signal that is transmitted from the each of the systems;
a dummy-information creating unit that creates dummy information by adding dummy data to identification information and destination information, the identification information indicating a head of proper data that is transmitted, in response to a data request from the system board, from one of the systems constituting the duplicated structure with the other system that has been determined as being degenerated by the degeneration determining unit, and the destination information indicating destination of the data; and
a data transmitting unit that transmits, as synchronized data, proper information that is transmitted from the one of the systems in response to a data request from the system board, and the dummy information that is created by the dummy-information creating unit.

2. The computer system according to claim 1, wherein the dummy-information creating unit uses, as a dummy data, poisoning data that is recognized as a dummy from a result of decoding by an error detecting code, and creates the dummy information by adding the poisoning data to the identification information and the destination information.

3. The computer system according to claim 1, wherein the dummy-information creating unit creates the dummy information by adding information indicating that it is a dummy to the identification information, the destination information, and the dummy data.

4. A data relay device that is connected to system boards each of which includes two systems arranged in a duplicated structure and that controls transmission of synchronized data transmitted from the system boards, the data relay device comprising:
a degeneration determining unit that determines whether each of the systems is degenerated based on a signal that is transmitted from the each of the systems;
a dummy-information creating unit that creates dummy information by adding dummy data to identification information and destination information, the identification information indicating a head of proper data that is transmitted, in response to a data request from the system board, from one of the systems constituting the duplicated structure with the other system that has been determined as being degenerated by the degeneration determining unit, and the destination information indicating destination of the data; and
a data transmitting unit that transmits, as synchronized data, proper information that is transmitted from the one of the systems in response to a data request from the system board, and the dummy information that is created by the dummy-information creating unit.

5. The data relay device according to claim 4, wherein the dummy-information creating unit uses, as a dummy data, poisoning data that is recognized as a dummy from a result of decoding by an error detecting code, and creates the dummy information by adding the poisoning data to the identification information and the destination information.

6. The data relay device according to claim 4, wherein the dummy-information creating unit creates the dummy information by adding information indicating that it is a dummy to the identification information, the destination information, and the dummy data.

7. A control method for a computer system in which system boards each of which includes two systems arranged in a duplicated structure are connected through a data relay device and in which synchronized data is communicated through the data relay device, the control method comprising:
determining whether each of the systems is degenerated based on a signal that is transmitted from the each of the systems;
creating dummy information by adding dummy data to identification information and destination information, the identification information indicating a head of proper data that is transmitted, in response to a data request from the system board, from one of the systems constituting the duplicated structure with the other system that has been determined as being degenerated in the determining, and the destination information indicating destination of the data; and
transmitting, as synchronized data, proper information that is transmitted from the one of the systems in response to a data request from the system board, and the dummy information that is created in creating.

8. The control method according to claim 7, wherein, in the creating, poisoning data that is recognized as a dummy from a result of decoding by an error detecting code is used as a dummy data, and the dummy information is created by adding the poisoning data to the identification information and the destination information.

9. The control method according to claim 7, wherein, in the creating, the dummy information is created by adding information indicating that it is a dummy to the identification information, the destination information, and the dummy data.
